(19) United States
(12) Patent Application Publication
(10) Pub. No.: US 2011/0095202 A1
(43) Pub. Date: Apr. 28, 2011

(54) BOOK STERILIZER

(76) Inventor: Jong Min Lee, Seongnam-si (KR)

(21) Appl. No.: 12/888,673

(22) Filed: Sep. 23, 2010

(30) Foreign Application Priority Data
Oct. 27, 2009 (KR) 2009-0102422

(51) Int. Cl. G21K 5/08

(52) U.S. Cl. 250/453.11

(57) ABSTRACT

A book sterilizer is provided, which includes a sterilizing chamber having an upper wall, a lower wall, and an inclined rear wall between the upper and lower walls, and at least one holding member for a book which is provided in the sterilizing chamber and has a free end adjacent to the inclined rear wall, so that a book is easily held by virtue of having been inserted between the inclined rear wall and the holding member with the leaves and book covers separately opened such that they unfold under their own weight and gravity, so that upon spraying air, the book covers and the leaves of the book smoothly unfold and thus sterilizing rays from a sterilization and disinfection lamp are uniformly radiated deep into the book covers and the leaves, thereby providing excellent sterilizing effects at an economical cost.

### BACKGROUND OF THE INVENTION

1. Field of the Invention

The present invention relates, in general, to a book sterilizer and, more particularly, to a book sterilizer which conveniently and effectively sterilizes or disinfects books in a library, an archive, a morgue, a school, a home or the like, using ultraviolet rays or infrared rays, while allowing for a user to hold a book in a sterilizing chamber with ease.

2. Description of the Related Art

Generally, various kinds of books which are read or checked out of libraries, schools, etc. may become carriers of disease when they are contaminated or infected with body secretions such as saliva, nasal mucus, sweat or the like, foods such as coffee, drinks, candies or the like, or harmful insects such as bookworms or the like, so that diverse kinds of viruses, bacteria, mold and the like are easily cultivated.

Particularly in the case of various kinds of viruses, bacteria, mold, harmful insects and the like whose habitat in a book, i.e. the leaves of a book, is subject to contamination, this habitat is difficult to effectively sterilize or disinfect with a conventional ultraviolet sterilizer because the ultraviolet rays are intercepted by the book covers and other leaves.

In order to solve these problems, the applicant has proposed a book sterilizer disclosed in Korean patent No. 0880583.

The above-mentioned book sterilizer includes a book holding means having a book holder stage and a book fixture for holding a book in a vertical position while the book covers are unfolded. Thus, the lower portion of the rising book, i.e. the lower portion of the leaves of the book, is brought into contact with the bottom of a sterilizing chamber. However, this causes a problem in that, when air is sprayed towards the leaves to unfold the same in the shape of a fan for the purpose of sterilization, the leaves may not smoothly unfold because of the resistance caused by friction between the lower portion of the leaves and the bottom of the sterilizing chamber.

Further, another problem is that it is inconvenient for a user to use the book sterilizer because when it is being used, the user has to manipulate the book fixture for holding a book in the holding means in such a manner that he holds the book with his one hand such that the book does not fall down, while he separates the leaves from the book covers using his other hand.

Particularly, it is very inconvenient to hold a large or heavy book such as a large volume picture book for children, and it is also difficult for children or the elderly or the disabled, whose gripping power is weaker than that of ordinary people, to hold a book in the book sterilizer.

Further, since the holding means consists of the holding stage for vertically holding the book and a pair of movable book fixtures which pivot and are foldable, the book sterilizer has a relatively complex structure thus necessitating many processing steps when being assembled during manufacturing, which increases the manufacturing cost.

### SUMMARY OF THE INVENTION

Accordingly, the present invention has been made keeping in mind the above problems occurring in the related art, and the present invention is intended to propose a book sterilizer, in which a book is easily held because of being inserted between an inclined rear wall and a holding member, which are provided in a sterilizing chamber, while the leaves and book covers have been separately opened such that they are unfolded under their own weight and gravity, so that, when air is sprayed towards a book for sterilization purposes, the book covers and the leaves of the book smoothly unfold so that sterilizing rays from a sterilization and disinfection lamp are uniformly radiated deep into the book covers and the leaves, thereby providing excellent sterilizing effects at an economical cost.

In order to achieve the above object, according to one aspect of the present invention, there is provided a book sterilizer for sterilizing a book using a sterilizing lamp, the book sterilizer including a sterilizing chamber having an upper wall, a lower wall, and an inclined rear wall between the upper and lower walls; at least one holding member for a book provided in the sterilizing chamber and having a free end adjacent to the inclined rear wall; and at least one air injector provided on the upper, lower, and rear walls of the sterilizing chamber and all connected together by a fan.

In an exemplary embodiment, a holding end of the holding member may be fixed to any one of upper, lower, and rear walls of the sterilizing chamber.

In an exemplary embodiment, a book-support stage may be provided to work in conjunction with the holding member and is located towards the inclined rear wall.

In an exemplary embodiment, a magnet may be provided to work in conjunction with the free end of the holding member and is on the inclined rear wall.

According to the above-mentioned construction of the book sterilizer, since a book is easily held because it has been inserted between the inclined rear wall and the free end of the holding member, which are provided in the sterilizing chamber, with the leaves and book covers separately laid open, the book is easily held and sterilized by an ordinary person as well as by children and the elderly and the disabled.

Since the leaves and covers of the book unfold under their own weight and because of gravity, when air is sprayed towards the book for sterilization purposes, the book covers and the leaves of the book smoothly unfold and thus sterilizing rays from a sterilization and disinfection lamp are uniformly radiated deep into the book covers and the leaves, thereby providing excellent sterilizing effects at an economical cost.

Moreover, since the book sterilizer may have many holding members and book-support stages in parallel in the sterilizing chamber, many books may be advantageously sterilized and disinfected effectively at the same time.

### BRIEF DESCRIPTION OF THE DRAWINGS

The above and other objects, features and advantages of the present invention will be more clearly understood from the following detailed description when taken in conjunction with the accompanying drawings, in which:

FIG. 1 is a cross-sectional view illustrative of an exemplary embodiment of a book sterilizer according to the present invention; and

FIG. 2 is a perspective view illustrative of the state in which the book covers and leaves of a book that is suspended in a sterilizing chamber of the book sterilizer have been unfolded under their own weight and because of gravity and an air jet.

### DETAILED DESCRIPTION OF THE INVENTION

Reference will now be made in greater detail to a preferred embodiment of the invention, an example of which is illustrated in the accompanying drawings. Wherever possible, the same reference numerals will be used throughout the drawings and the description to refer to the same or like parts.

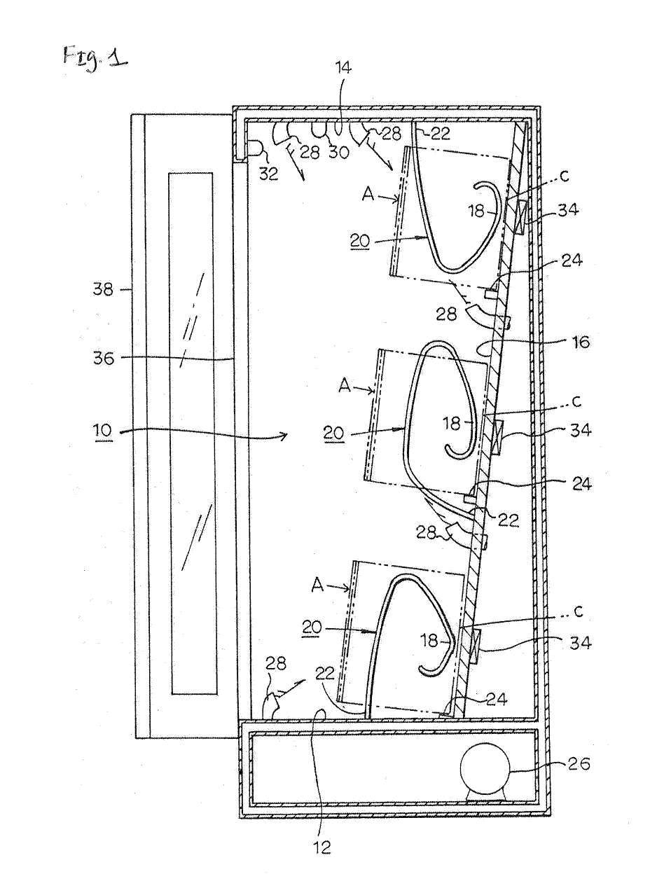

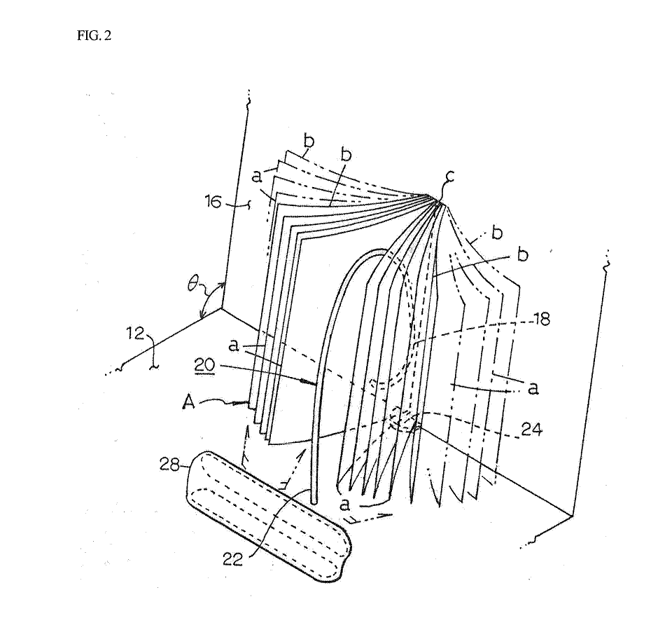

FIG. 1 is a cross-sectional view illustrative of an exemplary embodiment of a book sterilizer according to the present invention, and FIG. 2 is a perspective view illustrative of the state in which the book covers and leaves of a book that is being held in the sterilizing chamber of the book sterilizer have unfolded because of their own weight and gravity, and an air jet.

As illustrated in FIGS. 1 and 2, the book sterilizer includes a sterilizing chamber 10 having an upper wall 14, a lower wall 12, and an inclined rear wall 16 between the upper and lower walls 14 and 12. The sterilizing chamber 10 is provided with at least one holding member 20 for a book having a free end 18 adjacent to the inclined rear wall 16. A book A to be sterilized is held on the holding member for sterilization in such a manner that a book-spine c is inserted between the inclined rear wall 16 and the holding member 20 after the book covers a and the leaves b of the book A have been opened into two parts.

The holding member 20 is made of a high tensile metal such as a steel rod, and a holding end 22 of the holding member 20 is fixed to the upper wall 14, the lower wall 12, or the inclined rear wall 16 of the sterilizing chamber 10, for example.

In an exemplary embodiment, a book-support stage 24 is provided to correspond to the holding member 20 towards the inclined rear wall 16, so as to support lower edges of the book A, the book-spine c of which is inserted in an inclined form between the inclined rear wall 16 and the holding member 20.

Further, an air injector connected with a fan 26, an ultraviolet sterilizing lamp 31, and an infrared lamp 32 are provided on the side of the lower wall 12, the inclined rear wall 16, or the upper wall 14 of the sterilizing chamber 10.

In an exemplary embodiment, a magnet 34 such as a permanent magnet or an electric magnet is provided to be used in conjunction with the free end 18 of the holding member 20 on the inclined rear wall 16, so that the book-spine c of the book A can be held between the rear wall 16 and the free end 18 of the holding member 20 in a more stable and firm manner. The holding member 20 is configured such that it is movable towards the inclined rear wall 16.

The sterilizing chamber 10 may be fabricated for example as an open type sterilizing chamber that has an opening 36, or an open-and-shut type that has a door 38 which is able to open and close.

An inclined angle (θ) between the lower wall 12 and the rear wall 16 ranges from 92° to 100°, preferably, so that, when the book-spine c of the book A is held between the holding member 20 and the rear wall 16 in a state where the book A has been opened into two parts as shown in FIGS. 1 and 2, the leaves a and the book covers b of the held book A are unfolded by themselves to form a fan shape represented by the solid line of FIG. 2 under their own weight and gravity without being subject to the resistance of friction. In this state, if air is sprayed into the book by the air injector, the leaves a and the book covers b of the held book A unfold well in a smoother manner as shown by the dashed dotted line in FIG. 2.

Thus, sterilizing rays from the ultraviolet lamp 30 and the infrared lamp 32 are uniformly radiated deep into the leaves a and the book covers b of the held book A so as to greatly improve the effect of sterilizing the book A.

Further, the holding member 20 is simply fabricated by bending metal such as a steel rod, so as to reduce the manufacturing cost.

Furthermore, the air injectors 28 may be operated at the same time or alternately in order to improve the sterilizing effect.

Although preferred embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A book sterilizer for sterilizing a book using a sterilizing lamp, the book sterilizer comprising:
a sterilizing chamber having an upper wall, a lower wall, and an inclined rear wall between the upper and lower walls;
at least one holding member for a book provided in the sterilizing chamber, the holding member having a free end adjacent to the inclined rear wall; and
at least one air injector provided on the upper, lower, and rear walls of the sterilizing chamber and all connected together by a fan.

2. The book sterilizer according to claim 1, wherein a holding end of the holding member is fixed to the lower wall of the sterilizing chamber.

3. The book sterilizer according to claim 1, wherein a holding end of the holding member is fixed to the inclined rear wall of the sterilizing chamber.

4. The book sterilizer according to claim 1, wherein a holding end of the holding member is fixed to the upper wall of the sterilizing chamber.

5. The book sterilizer according to claim 1, wherein a book-support stage is provided to work in conjunction with the holding member and is located towards the inclined rear wall.

6. The book sterilizer according to claim 1, wherein a magnet is provided to work in conjunction with the free end of the holding member and is on the inclined rear wall.
